(19) United States
(12) Patent Application Publication
(10) Pub. No.: US 2012/0134288 A1
(43) Pub. Date: May 31, 2012

(54) METHOD, SYSTEM AND DEVICE FOR DETERMINING POSITION INFORMATION OF USER EQUIPMENT

(75) Inventors: Jiayi Fang, Haidian District (CN); Haiyang Quan, Haidian District (CN)

(73) Assignee: CHINA ACADEMY OF TELECOMMUNICATIONS TECHNOLOGY, Beijing (CN)

(21) Appl. No.: 13/319,225

(22) PCT Filed: May 7, 2010
(86) PCT No.: PCT/CN10/72511

§ 371 Date: Jan. 24, 2012

(30) Foreign Application Priority Data
May 7, 2009 (CN) 200910083875.1

(51) Int. Cl. H04W 24/00

(52) U.S. Cl. 370/252

(57) ABSTRACT

A method, system and device for determining the position of a user terminal are used to solve the problem that it is unable to determine the position information of the user terminal in long term evolution (LTE) systems existing in the prior art. The method of an embodiment comprises: a network side determines the measure value of timing advance (TA) according to the actual arrival time and the expected arrival time of a contention-free random access preamble sequence from the user terminal (501); the network side determines the position information of the user terminal according to the determined measure value of TA (502). The position information of the user terminal can be determined in LTE systems through employing the method of the embodiment, and then the user terminal is located.

### CROSS-REFERENCE TO RELATED APPLICATIONS

This application is a US National Stage of International Application No. PCT/CN2010/072511, filed 7 May 2010, designating the United States, and claiming the benefit of CN Application No. 200910083875.1 filed on May 7, 2009, entitled “METHOD, SYSTEM AND DEVICE FOR DETERMINING POSITION INFORMATION OF USER EQUIPMENT”.

### FIELD OF THE INVENTION

The present invention relates to the field of radio communications, and in particular, to a method, a system and a device for determining position information of a user equipment.

### BACKGROUND OF THE INVENTION

Positioning function may provide various services for a user, such as working, entertainment and life. A typical positioning service includes: an aid service, such as an emergent medical service and emergent positioning; a position-based information service, for example, searching for information of the nearest restaurant and recreation place, and yellow-page query; an advertisement service, for example, information of sales promotion and discount; and a position-based charging and tracking service.

User Equipment (UE) positioning technology is mainly divided into three types: network-based service, without the aid of a mobile station; a technology based on network service and a mobile station; and a Global Positioning Systems (GPS) technology.

Positioning service is divided, according to time limit, into user layer-based positioning and control layer-based positioning, where for control layer-based positioning, position-related data is on a standard signalling link and is interacted between the user equipment and a Serving Mobile Location Centre (SMLC). Control layer-based services are mainly applied to emergency-type services.

In the existing Universal Mobile Telecommunications System (UMTS), a plurality of positioning technologies are used, including the technology based on network service and a mobile station.

Specifically, a Radio Network Controller (RNC) triggers a user equipment to measure. The user equipment reports the measurement result and the time the result is measured (i.e., system frame number (SFN)) to the network. The network determines the position of the user equipment in conjunction with the measurement result reported by the user equipment and the geographical position of the cell.

In the current Long Term Evolution (LTE) system, there exists no solution for determining the position information of a user equipment, so it is difficult to position a user equipment.

In conclusion, at present, in the LTE system, there exists no solution for determining the position information of a user equipment, so it is difficult to position a user equipment.

### SUMMARY OF THE INVENTION

The embodiments of the invention provide a method, a system and a device for determining position information of a user equipment, to address the problem that it cannot determine the position information of the user equipment in the LTE system.

An embodiment of the invention provides a method for determining position information of a user equipment, including:

determining, by the network side, a measurement value of timing advance (TA) according to actual arrival time and expected arrival time of a contention-free random access preamble sequence from the user equipment; and

determining, by the network side, the position information of the user equipment according to the measurement value of TA.

An embodiment of the invention provides a system for determining position information of a user equipment, including:

a radio access network device, configured to determine a measurement value of timing advance (TA) according to actual arrival time and expected arrival time of a contention-free random access preamble sequence from the user equipment; and

a positioning device, configured to determine the position information of the user equipment according to the measurement value of TA.

An embodiment of the invention provides a radio access network device, including:

a receiving module, configured to receive a contention-free random access preamble sequence from a user equipment; and

a first determining module, configured to determine a measurement value of timing advance (TA) according to actual arrival time and expected arrival time of the contention-free random access preamble sequence from the user equipment.

In the embodiments of the invention, the network side determines a measurement value of timing advance (TA) according to actual arrival time and expected arrival time of a contention-free random access preamble sequence from a user equipment; and the network side determines position information of the user equipment according to the measurement value of TA. Because in an LTE system, the measurement value of TA can be determined via a contention-free random access, the position information of the user equipment may be determined in the LTE system, thereby the user equipment may be positioned; moreover, the solutions of the embodiments of the invention are easy to be implemented, thereby various services may be provided for a user in the LTE system via the positioning function.

### BRIEF DESCRIPTION OF THE DRAWINGS

FIG. 1 is a schematic diagram of a timing relationship of an LTE TDD (Time division duplex) system according to an embodiment of the invention;

FIG. 2A is a schematic diagram for positioning a user equipment according to an embodiment of the invention;

FIG. 2B is another schematic diagram for positioning a user equipment according to another embodiment of the invention;

FIG. 3 is a schematic structural diagram of a system for determining position information of a user equipment according to an embodiment of the invention;

FIG. 4 is a schematic structural diagram of a radio access network device according to an embodiment of the invention; and

FIG. 5 is a schematic flow chart of a method for determining position information of a user equipment according to an embodiment of the invention.

### DETAILED DESCRIPTION OF THE EMBODIMENTS

In the embodiments of the invention, the network side determines a measurement value of timing advance TA according to actual arrival time and expected arrival time of a contention-free random access preamble sequence from a user equipment; and the network side determines position information of the user equipment according to the measurement value of TA. Because in an LTE system, a measurement value of TA can be determined via a contention-free random access, position information of a user equipment may be determined in the LTE system, thereby the user equipment may be positioned.

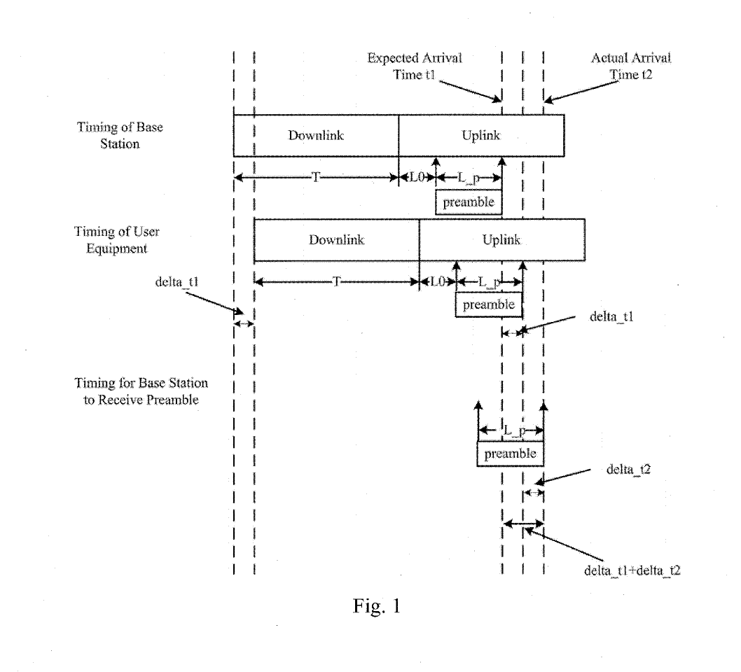

As shown in FIG. 1, in a schematic diagram of a timing relationship of an LTE TDD system according to an embodiment of the invention, T represents the length of each subframe, L0 represents the position advance of the uplink subframe on which the preamble (random access preamble sequence) exists (depending on the frame structure), and L_p represents the length of the preamble (depending on factors such as a preamble format).

A delay of delta_t1 exists when a downlink subframe arrives. When the preamble in the uplink direction arrives at the radio access network device side, a delay of delta_t2 is further generated.

In summary, at the network side, the expected arrival time of the preamble (the expected time the receiving of the preamble is completed) t1=T+L0+L_p. However, the actual arrival time of the preamble at the network side (the actual time the receiving of the preamble is completed) t2=t1+delta_t1+delta_t2. The difference therebetween is delta_t1+delta_t2.

Because a period of time for a user equipment to receive indication information and send a preamble is very short, that is, the distance between the user equipment and the radio access network device may be regarded as invariable approximatively, the delta_t1 and the delta_t2 is equal to each other. Thus, the distance between the user equipment and the radio access network device is d=(delta_t1+delta_t2)*(½)*C (C represents the velocity of light).

When the embodiment of the invention is implemented at a user equipment, a new downlink timing may be used before sending the preamble code, or a new downlink timing may be obtained by directly performing a downlink synchronization process, thus it can be guaranteed that downlink transmission delay and uplink transmission delay are substantially the same.

Thus, the base station may obtain a measurement value of Timing Advance (TA) by receiving the preamble, and then estimate the relative distance between the user equipment and the base station. Thus, a CELL ID+TA positioning method may be implemented further in conjunction with the known geographical position information of the base station.

Moreover, the base station may additionally obtain a measurement value of Angle of Arrival (AOA) by processing the preamble signal, so that angle information of the user equipment seen from the base station side may be obtained, thereby implementing a CELL ID+TA+AOA positioning method.

It shall be noted that, the embodiments of the invention may be applicable to an LTE system, the LTE TDD system in FIG. 1 is only an illustrative example, and the embodiments of the invention may be further applied to an LTE FDD (Frequency division duplex) system.

The radio access network device in the embodiments of the invention may be a base station or a relay node (RN) device.

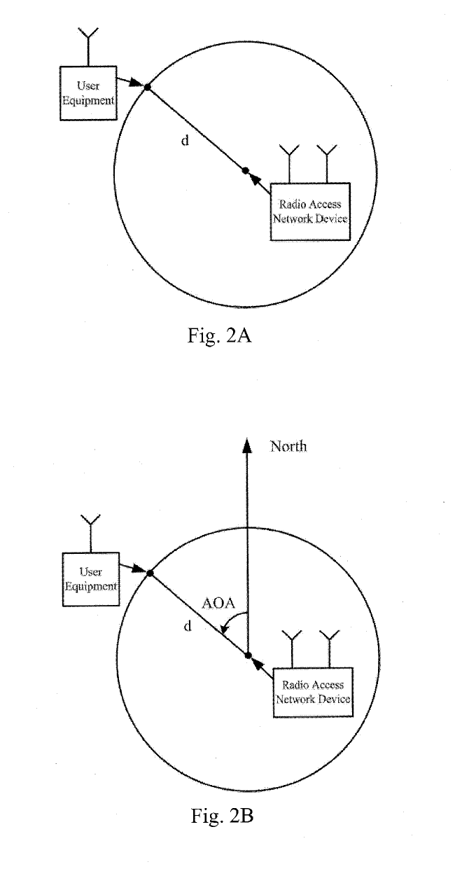

As shown in FIG. 2A, which is a schematic diagram for positioning a user equipment according to an embodiment of the invention, after determining the measurement value of TA, it may be determined that the user equipment is on a circle that takes the radio access network device as a center and a product of the measurement value of TA and the velocity of light as a radius; that is, the relative geographical position of the user equipment from the radio access network device may be determined. Because the absolute geographical position (for example, geographical information such as longitude and latitude) of each radio access network device is already known, the absolute geographical position of the radio access network device may be queried according to the CELL ID of the radio access network device in which the user equipment currently exists, and finally the absolute geographical position of the user equipment may be obtained further in conjunction with the relative position of the user equipment from the radio access network device just obtained, thereby implementing the CELL ID+TA positioning method.

As shown in FIG. 2B, which is another schematic diagram for positioning a user equipment according to another embodiment of the invention, after determining the measurement value of TA, it may be determined that the user equipment is on a circle that takes the radio access network device as a center and a product of the measurement value of TA and the velocity of light as a radius.

After the measurement value of Angel Of Arrival (AOA) is determined, it may be known that the user equipment is on a half line that takes the radio access network device as the starting point, and an angle that the half line rotates anticlockwise from the true north direction is the measurement value of AOA.

In conjunction with the measurement value of TA and the measurement value of AOA, the position of the user equipment relative to the radio access network device may be uniquely determined in a polar coordinate system that takes the radio access network device as the center.

Because the absolute geographical position (for example, geographical information such as longitude and latitude) of each radio access network device is already known, the absolute geographical position of the radio access network device may be queried according to the CELL ID of the radio access network device in which the user equipment currently exists, and finally the absolute geographical position coordinate of the user equipment may be obtained further in conjunction with the relative position of the user equipment from the radio access network device just obtained.

It shall be noted that, rotating anticlockwise from the true north direction is only an illustrative example, and any direction may be taken as the standard as required, the rotation angle may also be varied; for example, rotating clockwise from the true south direction may be taken as a standard. However, after the standard is modified, a corresponding adjustment is needed when the measurement value of AOA is measured.

In the embodiment of the invention, the reason a contention-free random access is used lies in that: during a contention random access process, the same preamble code may be used by a plurality of user equipments simultaneously (i.e., collision occurs), the network side cannot make a one-to-one correspondence between the preamble and the user equipment; however, when the contention-free random access is employed, it may be guaranteed that a preamble code is dedicated to a certain user equipment, thus the network side can make a one-to-one correspondence between the measurement value and the user equipment after measuring.

The embodiments of the invention will be further described in detail below in conjunction with the drawings.

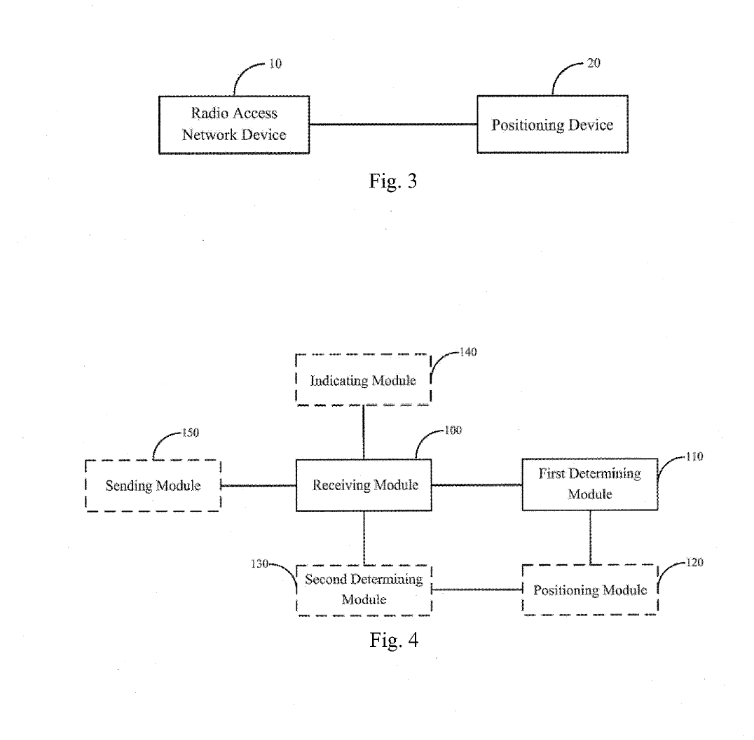

As shown in FIG. 3, a system for determining position information of a user equipment according to an embodiment of the invention includes a radio access network device 10 and a positioning device 20.

The radio access network device 10 is configured to determine a measurement value of TA according to actual arrival time and expected arrival time of a contention-free random access preamble sequence from a user equipment.

The positioning device 20 is configured to determine the position information of the user equipment according to the measurement value of TA determined by the radio access network device 10.

The positioning device 20 may be any device in the network (for example, a base station 10), or other separate network side devices (for example, the SMLC), or a new device.

In the specific implementations, there are two positioning modes: 1) determining the position information of the user equipment according to the measurement value of TA; 2) determining the position information of the user equipment according to the measurement value of TA and a measurement value of AOA.

For the first mode, the radio access network device 10 determines the actual arrival time of the contention-free random access preamble sequence received from the user equipment, obtains the difference between the actual arrival time and the expected arrival time as TA, and divides TA by 2 as the measurement value of TA.

Correspondingly, the positioning device 20 determines the position information of the user equipment according to the measurement value of TA determined by the radio access network device 10.

The expected arrival time is obtained by the network side according to the downlink timing, a position of a set Physical Random Access Channel (PRACH) and a sending position of the preamble signal; for example, in FIG. 1, the PRACH resource set by the network side is located on the uplink subframe, the starting position of the uplink subframe is marked as T, and the network side determines that the sending time of the preamble is time L0 after the header of the uplink subframe, and the length of the preamble is L_p, thus the expected arrival time is T+L0+L_p.

For the second positioning mode, in addition to determining the measurement value of TA, the radio access network device 10 further needs to measure a signal angle of the contention-free random access preamble sequence received from the user equipment and determine the measurement value of angle of arrival (AOA) according to the measured signal angle.

Correspondingly, the positioning device 20 determines the position information of the user equipment according to the measurement value of TA and the measurement value of AOA determined by the radio access network device 10.

If the radio access network device 10 only determines the measurement value of TA (i.e., the CELL ID+TA positioning mode is employed), the complexity of the radio access network device may be reduced and the cost may be saved; but in comparison with the mode in which the radio access network device 10 determines the measurement value of TA and the measurement value of AOA (i.e., the CELL ID+TA+AOA mode is employed), positioning accuracy will be lowered.

The specific positioning mode may be selected as required.

Before the radio access network device 10 receives the contention-free random access preamble sequence from the user equipment, the radio access network device 10 needs to send indication information for performing a contention-free random access to the user equipment, where the indication information includes PRACH time-frequency resource information and contention-free random access preamble sequence (i.e., the preamble code).

Where the indication information may be one of the following information:

Physical Downlink Control Channel (PDCCH), Media Access Control (MAC) Protocol Data Unit (PDU), and Radio Resource Control (RRC) signalling.

Where the positioning device 20 may perform positioning when the radio access network device 10 receives the contention-free random access preamble sequence only once, thus network resources may be saved, but positioning precision will be low. To improve the positioning precision, the radio access network device 10 may receive the contention-free random access preamble sequence for multiple times and determine a plurality of measurement values to perform positioning, thus the positioning precision may be improved.

If the user equipment is required to send the contention-free random access preamble sequence for multiple times, the number of times the user equipment needs to send the contention-free random access preamble sequence may be carried in the indication information, or triggering reason information may be carried in the indication information, where the triggering reason information is used for notifying the user equipment that positioning is performed by sending the contention-free random access preamble sequence.

If the number of times is carried, the user equipment sends the contention-free random access preamble sequence for multiple times according to the number of times specified; if the triggering reason information is carried, the number of sending times may be preset, for example, the number of sending times may be specified in the protocol or may be notified to the user equipment by the network side, thus when the user equipment determines that positioning needs to be performed by sending the contention-free random access preamble sequence, the user equipment may send the contention-free random access preamble sequence for multiple times according to the preset number of sending times.

In an implementation, information of a plurality of PRACH time-frequency resources and a plurality of contention-free random access preamble sequences for a plurality of contention-free random accesses may be added to the indication information.

Because, if no random access response message (Msg2) is received after the user equipment receives the indication information and sends the contention-free random access preamble sequence, the user equipment may send the contention-free random access preamble sequence again, the effect of multiple and repeated sending may be attained. Specifically, after receiving the contention-free random access preamble sequence, the radio access network device 10 does not send a random access response message to the user equipment (thus, the user equipment may resend the contention-free random access preamble sequence), and when the number of times the contention-free random access preamble sequence is received equals to a set threshold, the radio access network device 10 sends a random access response message to the user equipment to instruct the user equipment to stop sending the contention-free random access preamble sequence.

The value of the threshold may be set as required.

If the position information of the user equipment is determined according to the measurement value of TA:

the radio access network device 10 may determine one measurement value of TA after one contention-free random access preamble sequence is received; or determine a measurement value of TA according to each of contention-free random access preamble sequences after all of the contention-free random access preamble sequences are received.

Then, the positioning device 20 may add and average the plurality of measurement values of TA that are determined to obtain an average measurement value of TA, and determine the position information of the user equipment according to the average measurement value of TA.

The positioning device 20 may also determine a position coordinate corresponding to each measurement value of TA of the plurality of measurement values of TA, and average all the determined position coordinates, and take the determined average coordinate as the position information of the user equipment.

For example, there are totally 3 position coordinates (X1, Y1), (X2, Y2) and (X3, Y3), then the average coordinate is

$$( \frac{X 1 + X 2 + X 3}{3} , \frac{Y 1 + Y 2 + Y 3}{3} ) .$$

If the position information of the user equipment is determined according to the measurement value of TA and the measurement value of AOA:

the radio access network device 10 may determine one measurement value of TA and one measurement value of AOA after receiving one contention-free random access preamble sequence; or determine a measurement value of TA and a measurement value of AOA according to each of contention-free random access preamble sequences after receiving all of the contention-free random access preamble sequences.

Then, the positioning device 20 may respectively add and average the plurality of measurement values of TA and the plurality of measurement values of AOA that are determined to obtain an average measurement value of TA and an average measurement value of AOA, and determine the position information of the user equipment according to the average measurement value of TA and the average measurement value of AOA.

The positioning device 20 may also group the plurality of measurement values of TA and the plurality of measurement values of AOA that are determined.

Where each group includes one measurement value of TA and one measurement value of AOA, and the measurement value of TA and the measurement value of AOA in the same group are determined from the same contention-free random access preamble sequence.

One position coordinate is determined according to the measurement value of TA and the measurement value of AOA in each group, all of the determined position coordinates are averaged, and the determined average coordinate is taken as the position information of the user equipment.

The specific mode employed by the positioning device 20 may be set as required.

As shown in FIG. 4, a radio access network device according to an embodiment of the invention includes a receiving module 100 and a first determining module 110.

The receiving module 100 is configured to receive a contention-free random access preamble sequence from a user equipment.

The first determining module 110 is configured to determine a measurement value of TA according to actual arrival time and expected arrival time of the contention-free random access preamble sequence received from the user equipment by the receiving module 100.

The radio access network device according to the embodiment of the invention may further include a positioning module 120.

The positioning module 120 is configured to determine position information of the user equipment according to the measurement value of TA determined by the first determining module 110.

In an implementation, the positioning module 120 may perform positioning in two positioning modes: 1) determining the position information of the user equipment according to the measurement value of TA; 2) determining the position information of the user equipment according to the measurement value of TA and a measurement value of AOA.

For the first mode, the mode for the first determining module 110 to determine the measurement value of TA is the same as the mode for the radio access network device 10 to determine the measurement value of TA shown in FIG. 3, the description thereof is omitted here.

Correspondingly, the positioning module 120 determines the position information of the user equipment according to the measurement value of TA determined by the first determining module 110.

For the second positioning mode, the radio access network device according to the embodiment of the invention may further include a second determining module 130.

The second determining module 130 is configured to measure a signal angle of the contention-free random access preamble sequence received from the user equipment by the receiving module 100, and determine a measurement value of angle of arrival (AOA) according to the measured signal angle.

Correspondingly, the positioning module 120 determines the position information of the user equipment according to the measurement value of TA determined by the first determining module 110 and the measurement value of AOA determined by the second determining module 120.

The specific positioning mode may be selected as required.

Before receiving the contention-free random access preamble sequence from the user equipment, the radio access network device needs to send indication information for performing a contention-free random access to the user equipment, thus the radio access network device according to the embodiment of the invention may further include an indicating module 140.

The indicating module 140 is configured to send indication information for performing a contention-free random access to the user equipment before the receiving module 100 receives the contention-free random access preamble sequence from the user equipment.

The indication information includes PRACH time-frequency resource information and contention-free random access preamble sequence (i.e., the preamble code).

If the user equipment is required to send the contention-free random access preamble sequence for multiple times, the indicating module 140 may carry the number of times the user equipment needs to send the contention-free random access preamble sequence in the indication information, or carry triggering reason information in the indication information, where the triggering reason information is used for notifying the user equipment that positioning is performed by sending the contention-free random access preamble sequence.

If the number of times is carried, the user equipment sends the contention-free random access preamble sequence for multiple times according to the number of times specified; if the triggering reason information is carried, the number of sending times may be preset, for example, the number of sending times may be specified in the protocol or notified to the user equipment by the network side, thus when the user equipment determines that positioning needs to be performed by sending the contention-free random access preamble sequence, the user equipment may send the contention-free random access preamble sequence for multiple times according to the preset number of sending times.

In an implementation, information of a plurality of PRACH time-frequency resources and a plurality of contention-free random access preamble sequences for multiple contention-free random accesses may be further added to the indication information.

Because, if no random access response message (Msg2) is received after the user equipment receives the indication information and sends the contention-free random access preamble sequence, the user equipment may send the contention-free random access preamble sequence again, thus the effect of multiple and repeated sending may be attained. Then, the radio access network device according to the embodiment of the invention may further include a sending module 150.

The sending module 150 is configured to examine, after the receiving module 100 receives the contention-free random access preamble sequence, whether the number of times the contention-free random access preamble sequence is received equals to a preset threshold; if not, the sending module 150 does not send a random access response message to the user equipment; otherwise, the sending module 150 sends a random access response message to the user equipment to instruct the user equipment to stop sending the contention-free random access preamble sequence.

The value of the threshold may be set as required.

If the position information of the user equipment is determined according to the measurement value of TA:

the first determining module 110 may determine one measurement value of TA after the receiving module 100 receives one contention-free random access preamble sequence; or determine a measurement value of TA according to each of contention-free random access preamble sequences after all of the contention-free random access preamble sequences are received by the receiving module 100.

The mode for the positioning module 120 to determine the position information of the user equipment according to a plurality of measurement values of TA is the same as the mode for the positioning device 20 to determine the position information of the user equipment according to a plurality of measurement values of TA shown in FIG. 3, the description thereof is omitted here.

If the position information of the user equipment is determined according to the measurement value of TA and the measurement value of AOA:

the first determining module 110 and the second determining module 120 may respectively determine one measurement value of TA and one measurement value of AOA after the receiving module 100 receives one contention-free random access preamble sequence; or, the first determining module 110 and the second determining module 120 may respectively determine a measurement value of TA and a measurement value of AOA according to each of contention-free random access preamble sequences after all of the contention-free random access preamble sequences are received by the receiving module 100.

The mode for the positioning module 120 to determine the position information of the user equipment according to a plurality of measurement values of TA and a plurality of measurement values of AOA is the same as the mode for the positioning device 20 to determine the position information of the user equipment according to a plurality of measurement values of TA and a plurality of measurement values of AOA shown in FIG. 3, the description thereof is omitted here.

The specific mode employed by the positioning module 120 may be set as required.

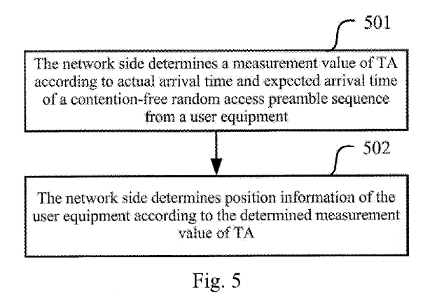

As shown in FIG. 5, a method for determining position information of a user equipment according to an embodiment of the invention includes the following steps.

Step 501: The network side determines a measurement value of TA according to actual arrival time and expected arrival time of a contention-free random access preamble sequence from a user equipment.

Step 502: The network side determines the position information of the user equipment according to the determined measurement value of TA.

In Step 502, the network side may perform positioning in two positioning modes: 1) determining the position information of the user equipment according to the measurement value of TA; 2) determining the position information of the user equipment according to the measurement value of TA and a measurement value of AOA.

For the first mode, in Step 501, the network side determines the actual arrival time of the contention-free random access preamble sequence received from the user equipment, obtains the difference between the actual arrival time and the expected arrival time as TA, and divides TA by 2 as the measurement value of TA.

Correspondingly, in Step 502, the network side determines the position information of the user equipment according to the determined measurement value of TA.

The expected arrival time is obtained by the network side according to the downlink timing, the set PRACH resource position and the sending position of the preamble signal; for example, in FIG. 1, the PRACH resource set by the network side is located on the uplink subframe, the starting position of the uplink subframe is marked as T, and the network side determines that the sending time of the preamble is time L0 after the header of the uplink subframe, and the length of the preamble is L_p, thus the expected arrival time is T+L0+L_p.

For the second positioning mode, in Step 501, in addition to determining the measurement value of TA, the network side further needs to measure a signal angle of the contention-free random access preamble sequence received from the user equipment and determine the measurement value of angle of arrival (AOA) according to the measured signal angle.

Correspondingly, in Step 502, the network side determines the position information of the user equipment according to the measurement value of TA and the measurement value of AOA that are determined.

If, in Step 501, the network side only determines the measurement value of TA (i.e., the CELL ID+TA positioning mode is employed), the complexity of the radio access network device may be reduced and the cost may be saved; but in comparison with the mode in which the measurement value of TA and the measurement value of AOA are determined (i.e., the CELL ID+TA+AOA mode is employed), positioning accuracy will be lowered.

The specific positioning mode may be selected as required.

Before Step 501, the method may further include the following step.

Step 500: The network side sends indication information for performing a contention-free random access to the user equipment, where the indication information includes PRACH time-frequency resource information and the contention-free random access preamble sequence (i.e., the preamble code).

Where the indication information may be one of the following information:

PDCCH, MAC PDU, and RRC signalling.

In Step 501, the network side may perform positioning when it receives the contention-free random access preamble sequence only once, thus network resources may be saved, but positioning precision will be low. To improve the positioning precision, the network side may receive the contention-free random access preamble sequence for multiple times and determine a plurality of measurement values to perform positioning, thus the positioning precision may be improved.

If the user equipment is required to send the contention-free random access preamble sequence for multiple times, the number of times the user equipment needs to send the contention-free random access preamble sequence may be carried in the indication information, or triggering reason information may be carried in the indication information, where the triggering reason information is used for notifying the user equipment that positioning is performed by sending the contention-free random access preamble sequence.

If the number of times is carried, the user equipment sends the contention-free random access preamble sequence for multiple times according to the number of times specified; if the triggering reason information is carried, the number of sending times may be preset, for example, the number of sending times may be specified in the protocol or may be notified to the user equipment by the network side, thus when the user equipment determines that positioning needs to be performed by sending the contention-free random access preamble sequence, the user equipment may send the contention-free random access preamble sequence for multiple times according to the preset number of sending times.

In an implementation, information of a plurality of PRACH time-frequency resources and a plurality of contention-free random access preamble sequences for a plurality of contention-free random accesses may be added to the indication information.

Because, if no random access response message (Msg2) is received after the user equipment receives the indication information and sends the contention-free random access preamble sequence, the user equipment may send the contention-free random access preamble sequence again, the effect of multiple and repeated sending may be attained. Specifically, in Step 501, after receiving the contention-free random access preamble sequence, the network side does not send a random access response message to the user equipment (thus, the user equipment may resend the contention-free random access preamble sequence), and when the number of times the contention-free random access preamble sequence is received equals to a set threshold, the network side sends a random access response message to the user equipment to instruct the user equipment to stop sending the contention-free random access preamble sequence.

The value of the threshold may be set as required.

If the position information of the user equipment is determined according to the measurement value of TA:

in Step 501, the network side may determine one measurement value of TA after one contention-free random access preamble sequence is received; or determine a measurement value of TA according to each of contention-free random access preamble sequences after all of the contention-free random access preamble sequences are received.

Then, in Step 502, the network side may add and average the plurality of measurement values of TA that are determined to obtain an average measurement value of TA, and determine the position information of the user equipment according to the average measurement value of TA.

In Step 502, the network side may also determine a position coordinate corresponding to each measurement value of TA of the plurality of measurement values of TA, and average all the determined position coordinates, and take the determined average coordinate as the position information of the user equipment.

If the position information of the user equipment is determined according to the measurement value of TA and the measurement value of AOA:

in Step 501, the network side may determine one measurement value of TA and one measurement value of AOA after receiving one contention-free random access preamble sequence; or determine a measurement value of TA and a measurement value of AOA according to each of contention-free random access preamble sequences after receiving all of the contention-free random access preamble sequences.

Then, in Step 502, the network side may respectively add and average the plurality of measurement values of TA and the plurality of measurement values of AOA that are determined to obtain an average measurement value of TA and an average measurement value of AOA, and determine the position information of the user equipment according to the average measurement value of TA and the average measurement value of AOA.

In Step 502, the network side may also group the plurality of measurement values of TA and the plurality of measurement values of AOA that are determined.

Where each group includes one measurement value of TA and one measurement value of AOA, and the measurement value of TA and the measurement value of AOA in the same group are determined from the same contention-free random access preamble sequence.

One position coordinate is determined according to the measurement value of TA and the measurement value of AOA in each group, all of the determined position coordinates are averaged, and the determined average coordinate is taken as the position information of the user equipment.

The specific mode employed by the network side in Step 502 may be set as required.

Because the measurement value of TA and the measurement value of AOA are measured at the network side, the complexity of the user equipment may be reduced. Moreover, the upgrade from the CELL ID+TA positioning technology to the CELL ID+TA+AOA positioning technology may be realized smartly, without influencing the user equipment.

When the CELL ID+TA+AOA technology is employed, the measurement value of TA and the measurement value of AOA are both measured on the basis of the same uplink transmission signal (the preamble code), so that estimation precision may be improved.

Because during the whole process, only the preamble is non-synchronously transmitted in the uplink direction, uplink interference may be avoided.

It can be seen from the above embodiments that, in the embodiments of the invention, the network side determines the measurement value of TA according to the actual arrival time and the expected arrival time of the contention-free random access preamble sequence from the user equipment; and the network side determines the position information of the user equipment according to the measurement value of TA. Because in an LTE system, the measurement value of TA can be determined via the contention-free random access, the position information of the user equipment may be determined in the LTE system, thereby the user equipment may be positioned; moreover, the solutions of the embodiments of the invention are easy to be implemented, thereby in an LTE system, various services may be provided for a user via the positioning function.

It will be appreciated that one skilled in the art may make various modifications and alterations to the present invention without departing from the scope of the present invention. Accordingly, if these modifications and alterations to the present invention fall within the scope of the claims of the present invention and their equivalents, the present invention intends to include all these modifications and alterations.

1. A method for determining position information of a user equipment, comprising:
determining, by the network side, a measurement value of timing advance, TA, according to actual arrival time and expected arrival time of a contention-free random access preamble sequence from the user equipment; and
determining, by the network side, the position information of the user equipment according to the measurement value of TA.

2. The method of claim 1, wherein determining the measurement value of TA by the network side comprises:
determining, by the network side, the actual arrival time of the contention-free random access preamble sequence received from the user equipment;
obtaining, by the network side, a difference between the actual arrival time and the expected arrival time as TA; and
dividing, by the network side, the TA by 2, as the measurement value of TA.

3. The method of claim 1, before determining the position information of the user equipment by the network side, further comprising:
measuring, by the network side, a signal angle of the contention-free random access preamble sequence received from the user equipment, and determining a measurement value of angle of arrival, AOA, according to the measured signal angle;
wherein determining the position information of the user equipment by the network side comprises:
determining, by the network side, the position information of the user equipment according to the measurement value of TA and the measurement value of AOA.

4. The method of claim 1, further comprising:
receiving, by the network side, the contention-free random access preamble sequence from the user equipment for multiple times;
wherein determining the measurement value of TA by the network side comprises:
determining, by the network side, a plurality of measurement values of TA according to actual arrival time and expected arrival time of a plurality of contention-free random access preamble sequences from the user equipment.

5. The method of claim 4, before receiving the contention-free random access preamble sequence by the network side from the user equipment, further comprising:
sending, by the network side, indication information for performing a contention-free random access to the user equipment, wherein the number of times the user equipment needs to send the contention-free random access preamble sequence is carried in the indication information, or triggering reason information is carried in the indication information, wherein the triggering reason information is used to notify the user equipment that positioning is performed by sending the contention-free random access preamble sequence.

6. (canceled)

7. The method of claim 4, wherein determining the position information of the user equipment by the network side comprises:
adding and averaging, by the network side, the plurality of measurement values of TA that are determined to obtain an average measurement value of TA, and determining the position information of the user equipment according to the average measurement value of TA.

8. The method of claim 7, before determining the position information of the user equipment by the network side, further comprising:
measuring, by the network side, signal angles of the plurality of contention-free random access preamble sequences received from the user equipment, and determining a plurality of measurement values of AOA according to the plurality of measured signal angles;
wherein determining the position information of the user equipment by the network side comprises:
adding and averaging, by the network side, the plurality of measurement values of AOA that are determined to obtain an average measurement value of AOA, and determining the position information of the user equipment according to the average measurement value of TA and the average measurement value of AOA.

9-10. (canceled)

11. A system for determining position information of a user equipment, comprising:
a radio access network device, configured to determine a measurement value of timing advance, TA, according to actual arrival time and expected arrival time of a contention-free random access preamble sequence from the user equipment; and
a positioning device, configured to determine the position information of the user equipment according to the measurement value of TA.

12. The system of claim 11, wherein the radio access network device is configured to:
determine the actual arrival time of the contention-free random access preamble sequence received from the user equipment, obtain a difference between the actual arrival time and the expected arrival time as TA, and divide the TA by 2 as the measurement value of TA.

13. The system of claim 11, wherein the radio access network device is further configured to:
measure a signal angle of the contention-free random access preamble sequence received from the user equipment, and determine a measurement value of angle of arrival, AOA, according to the measured signal angle;
and the positioning device is further configured to:
determine the position information of the user equipment according to the measurement value of TA and the measurement value of AOA.

14. The system of claim 11, wherein the radio access network device is further configured to:
receive the contention-free random access preamble sequence from the user equipment for multiple times;
and the radio access network device determines a plurality of measurement values of TA according to actual arrival time and expected arrival time of a plurality of contention-free random access preamble sequences from the user equipment.

15. The system of claim 14, wherein the radio access network device is further configured to:
send indication information for performing a contention-free random access to the user equipment before receiving the contention-free random access preamble sequence from the user equipment, wherein the number of times the user equipment needs to send the contention-free random access preamble sequence is carried in the indication information, or triggering reason information is carried in the indication information, wherein the triggering reason information is used to notify the user equipment that positioning is performed by sending the contention-free random access preamble sequence.

16. (canceled)

17. The system of claim 14, wherein the positioning device is configured to:
add and average the plurality of determined measurement values of TA to obtain an average measurement value of TA, and determine the position information of the user equipment according to the average measurement value of TA.

18-20. (canceled)

21. A radio access network device, comprising:
a receiving module, configured to receive a contention-free random access preamble sequence from a user equipment; and
a first determining module, configured to determine a measurement value of timing advance, TA, according to actual arrival time and expected arrival time of the contention-free random access preamble sequence from the user equipment.

22. The radio access network device of claim 21, further comprising:
a positioning module, configured to determine position information of the user equipment according to the measurement value of TA.

23. The radio access network device of claim 22, wherein the first determining module is configured to:
determine the actual arrival time of the contention-free random access preamble sequence received from the user equipment, obtain a difference between the actual arrival time and the expected arrival time as TA, and divide the TA by 2 as the measurement value of TA.

24. The radio access network device of claim 22, further comprising:
a second determining module, configured to measure a signal angle of the contention-free random access preamble sequence received from the user equipment, and determine a measurement value of angle of arrival, AOA, according to the measured signal angle;
and the positioning module is configured to:
determine the position information of the user equipment according to the measurement value of TA and the measurement value of AOA.

25. The radio access network device of claim 22, wherein the receiving module is configured to:
receive the contention-free random access preamble sequence from the user equipment for multiple times;
and the first determining module is configured to:
determine a plurality of measurement values of TA according to actual arrival time and expected arrival time of a plurality of contention-free random access preamble sequences from the user equipment.

26. The radio access network device of claim 25, further comprising:
an indicating module, configured to send indication information for performing contention-free random access to the user equipment before the receiving module receives the contention-free random access preamble sequence from the user equipment, wherein the number of times the user equipment needs to send the contention-free random access preamble sequence is carried in the indication information, or triggering reason information is carried in the indication information, wherein the triggering reason information is used to notify the user equipment that positioning is performed by sending the contention-free random access preamble sequence.

27. (canceled)

28. The radio access network device of claim 25, wherein the first determining module is configured to:
add and average the plurality of determined measurement values of TA to obtain an average measurement value of TA, and determine the position information of the user equipment according to the average measurement value of TA.

29-31. (canceled)
